(19) United States
(12) Patent Application Publication
(10) Pub. No.: US 2017/0354116 A1
(43) Pub. Date: Dec. 14, 2017

(54) METHOD FOR REDUCING INCIDENCE OF MASTITIS IN DAIRY ANIMALS USING AMINE OXIDE ANTISEPTIC COMPOSITIONS

(71) Applicant: GEA Farm Technologies, Inc., Naperville, IL (US)

(72) Inventors: Charles Gradle, Oak Park, IL (US); Lalitha William, Bolingbrook, IL (US); Solomon Brown, Romeoville, IL (US); Randall Richards, Dallas, TX (US)

(21) Appl. No.: 15/617,986

(22) Filed: Jun. 8, 2017

Related U.S. Application Data
(60) Provisional application No. 62/347,432, filed on Jun. 8, 2016.

(51) Int. Cl. A01J 7/04; C11D 1/40; C11D 1/88

(52) U.S. Cl. CPC A01J 7/04; C11D 1/886; C11D 1/40

(57) ABSTRACT

Methods and compositions for reducing the incidence of mastitis in dairy animals, the method comprising the steps of: topically applying an antimicrobial composition onto the teats or udder of the animal, the composition comprising: a first component comprising from about 2.0% to about 20.0% by weight of the composition of an amine oxide; and a second component comprising a germicide or an oxidizing agent.

### CROSS REFERENCE TO RELATED APPLICATION

This application claims the benefit of U.S. Provisional Application No. 62/347,432, filed Jun. 8, 2016, the disclosure of which is incorporated by reference herein.

### FIELD AND BACKGROUND OF THE INVENTION

The present disclosure relates to antiseptics. More particularly, it relates to antiseptics used on the teats and udders of dairy animals, such as dairy cows.

Microorganisms such as bacterial and fungal species can cause a serious infection in mammary glands of dairy animals, such as cows. This infection, which is commonly known as mastitis, has a significant economic impact on dairy farmers worldwide. Estimates suggest that there is a loss in income of from $125 to $200 per cow per year in the United States due to mastitis with an overall loss of 1.8 billion dollars annually. In other regions, such as Europe, the overall loss is 1.4 billion dollars per annum. The overall global loss per year is estimated at four billion to five billion dollars.

Dairy animals live in a challenging environment where they and their external milk-producing organs can be subjected to high levels of organic contaminants, which may compromise the ability of topical antiseptics to kill harmful microorganisms. The organic contaminants that the milk producing organs of these animals might be exposed to include soil, manure produced by the animals, and the bedding in which the animals lie, which may itself be composed of organic material such as wood chips, straw, or recycled manure.

One method that has been adopted to help prevent the incidence of mastitis in dairy cows and other dairy animals is the use of topical antiseptics, known in the industry as teat dips, teat (or udder) washes, teat wipes, foams, or sprays. These topical antiseptics are applied to the udder and especially the teats of dairy animals as a part of a general dairy hygiene regime. The antiseptics are designed to kill or debilitate the harmful microorganisms that can cause mastitis while on the skin of the teats and udder before they can be allowed to migrate or otherwise be propelled up into the teat canal where they can infect the mammary gland. Topical antiseptics are generally applied before and/or after every milking, which can number up to four or more times per day in some dairy harvesting facilities.

During the time just prior to milking and the time immediately after milking, teats frequently leak or drip milk, thereby contributing organic material that may mix with topical antiseptic when applied at the teat end. As a consequence, topical antiseptics need to be non-toxic both to the animals and to the humans applying them to the animals, as well as consumers of milk from the animals.

Additionally, after milking, the teats are frequently deflated from the loss of milk and are therefore wrinkled, which may block adequate penetration by topical antiseptics to those areas of the skin surface that are more sequestered. Furthermore, the teats themselves may be in a condition not conducive to topical antisepsis, such as when they may be injured, chapped, or otherwise in an unhealthy condition due to harsh weather conditions or the rigors of frequent milking, which may compromise normal teat skin defenses and harbor microorganisms.

Microorganisms also may be harbored near the orifice at the teat ends because of a condition known as hyperkeratosis, where the keratin naturally found within the teat canal is caused to extend from the teat orifice because of improper milker unit settings, malfunctions of the milking machinery, or by over-milking which occurs when the milking unit claw is left on for too long during milking. Further, due to the presence of organic material and less than optimal conditions for the teat skin and teat ends, any antimicrobial utilized for teat antisepsis must be chemically potent to be effective. A negative aspect to potency is that it might necessitate the use of chemically-strong oxidizers such as iodine and chlorine or compounds that are at a low (acidic) pH such as chlorine dioxide or mid-chain carboxylic (fatty) acids, which can be and frequently are irritating to the animal's skin, especially with frequent and repeated use over extended periods of time. It has been an ongoing challenge in the dairy industry to find antiseptics that fulfill both of the requirements for effectiveness and gentleness.

The antiseptics should not be irritating to the skin of the animal to which they are applied nor should they be harmful to consumers of milk contaminated by the antiseptics. Consequently, there is a need for antiseptics that are not only effective in killing or debilitating the microorganisms that cause mastitis, but that are also gentle to the skin and non-toxic to the consumers of the milk produced by the animals, and also the environment in which the animals are located should the chemicals get into the waste stream. Currently, some teat antiseptics include potent chemical antimicrobials having halogens, such as iodine or chlorine, as well as other chlorinated compounds such as chlorine dioxide that, at high enough concentrations for bactericidal efficacy, can in some cases produce potentially harmful residues in the milk. In addition, since many of these germicides work as oxidizing agents, they can and frequently do cause irritation to skin of the animals.

Other common germicides used in teat antiseptis such as biguanides including chlorhexidine and cationic agents such as quaternary ammonium salts at high enough concentrations for efficacy, can be harmful to skin tissue after frequent and long-term use, and are considered by many in the art not to be broad-spectrum enough since some microorganisms are known to survive in these germicides. Other antimicrobial chemicals, including alpha-hydroxy acids such as lactic acid and glycolic acid are not considered potent enough by themselves for most teat antiseptic applications. Others, including alcohols such as ethanol and n-propanol can act as de-fatting agents to skin tissue and therefore be irritating, whereas other germicides, including such oxidizing compounds as peroxides and peracids, can also be irritating to skin tissue.

As a consequence, there is a need in the art for an effective teat antiseptic that is also non-irritating to the skin of the milk-producing animal.

### SUMMARY OF THE INVENTION

The present invention is directed to compositions and methods for reducing the incidence of mastitis in dairy animals. An exemplary method for reducing the incidence of mastitis in dairy animals in accordance with the present invention includes the steps of: topically applying an antimicrobial composition onto the teats or udder of the animal, the composition having: a first component having from about 2.0% to about 20.0% by weight of the total composition of an amine oxide surfactant 0.01% to about 0.5% by weight of the total composition of one or more oxidizing agents such as hydrogen peroxide, peracids, alpha hydroxyl acids, or halogens. The second component can also include short-chained antiseptic alcohols or cationic agents such as quaternary ammonium compounds or glycol ethers.

The amine oxide can include N-Alkyl (C10-18) dimethylamine oxide, such as decyl dimethylamine oxide, lauryl (dodecyl) dimethylamine oxide or myristyl dimethyl amine oxide, or combinations thereof. The second component can include hydrogen peroxide, peroxyacetic acid, lactic acid, glycolic acid, tartaric acid, citric acid, mandelic acid, malic acid, or a halogen selected from the group comprising iodine derivatives, chlorine derivatives, bromine derivatives, or combinations thereof.

Another exemplary embodiment of a method for reducing the incidence of mastitis in dairy animals includes the steps of: topically applying an antimicrobial composition to a teat or udder of the animal where the antimicrobial composition includes: a first component having from about 2.0% to about 20.0% by weight of composition of one or more amine oxide surfactants; and a second component having from about 0.5% to about 20.0% by weight of composition of a germicide having one or more cationic agents, alcohols, or glycol ethers or combinations thereof. The second component can also include: a quaternary ammonium compound; didecyl dimethyl ammonium chloride such as chloride or monoalkyl dimethyl benzyl ammonium salts or monoalkyl dimethyl ammonium salts or heteroaromatic ammonium salts, or bis-quaternary ammonium salts; or phenoxyethanol. The second component can also include n-propanol, iso-propanol, ethanol, benzyl alcohol, methylene blue, or combinations thereof.

The invention is also directed to a method for reducing the incidence of mastitis in milk-producing animals, the method including the steps of: topically applying an antimicrobial composition to the teat or udder of the animal wherein the antimicrobial composition includes: a first component comprising from about 2.0% to about 20.0% by weight of composition of one or more amine oxide surfactants; and a second component having from about 0.5% to about 20.0% by weight of composition of a germicide comprising one or more mid-chain carboxylic acids. The mid-chain carboxylic acid can be selected from the group including: hexanoic acid, heptanoic acid, octanoic acid, nonanoic acid, decanoic acid, undecanoic acid, dodecanoic acid, tridecanoic acid, tetradecanoic acid, and combinations thereof.

Another method for reducing the incidence of mastitis in milk-producing animals in accordance with the present invention includes the steps of: topically applying an antimicrobial composition to the teat or udder of the animal, wherein the antimicrobial composition includes: a first component having from about 2.0% to about 20.0% by weight of the composition of one or more amine oxide surfactants; and a second component having from about 0.01% to about 0.5% by weight the composition of a germicide comprising: a peracid and an alpha hydroxyl acid; an alpha hydroxyl acid; a glycol ether; and combinations thereof.

Yet another method for reducing the incidence of mastitis in dairy animals includes the steps of: topically applying an antimicrobial composition to the teat or udder of the animal wherein the antimicrobial composition comprises: a first component comprising from about 2.0% to about 20.0% by weight of the composition of an amine oxide surfactant; and a second component comprising from about 0.01% to about 0.5% by weight of the composition of a germicide comprising a mid-chain carboxylic acid.

The second component can include: a mid-chain carboxylic acid selected from the group: hexanoic acid, heptanoic acid, octanoic acid, nonanoic acid, decanoic acid, undecanoic acid, dodecanoic acid, tridecanoic acid, tetradecanoic acid, and combinations thereof.

These and other features and advantages of various embodiments of compositions and methods according to this invention are described in, or are apparent from, the following detailed description of various exemplary embodiments of various compositions and methods of the present invention.

### DETAILED DESCRIPTION OF THE INVENTION

A topical germicidal composition in accordance with the present invention utilizes a class of surfactants known as amine oxides, in combination with germicidal ingredients to enhance the ability of those formulations to kill or debilitate microorganisms, such as bacterial and fungal species that can cause mastitis in dairy animals. The present invention minimizes teat irritation, toxicity, and residues while also acting as an effective agent for killing harmful mastitis-causing microbial pathogens on the teat and udder of dairy animals.

Amine oxides are amphoteric surfactants, which can be produced by the reaction of a tertiary amine with peroxide or peracetic acid. They are of the nomenclature where the functional group is R₃N⁺—O⁻, such as, for example:

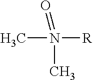

The methyl groups shown in the exemplary formula may be replaced with other R chains.

Furthermore, amine oxides are cationic when in an acidic medium, whereas they will react non-ionically in neutral or alkaline solutions. Examples of amine oxides of the dimethylamine oxide moiety include decyl dimethylamine oxide where the R group=10 (such as Barlox® 10S), lauryl dimethyl amine oxide where the R group=12 (such as Barlox® 12) and myristyl dimethyl amine oxide (such as Barlox® 14) where the R group=12. Other amine oxides that may also be included in the composition are cocamidopropylamine oxide, hexadecyl dimethylamine oxide, octyldecyl dimethyl amine oxide, lauryl/myristal, amidopropyl amine oxide, lauramine oxide, myristamine oxide, tallowamidopropyl dimethylamine oxide, bis (2-hydroxyethyl) cocamine admidopropyloxide, dimethyl (hydrogenated tallow) amine oxide, bis (2-hydroxyethyl) tallowamine oxide, octyl dimethyl amine oxide, coco dimethyl amine oxide, alkyl (C12-C18) dimethyl amine oxide, alkyl (C12-C16) dimethyl amine oxide, alkyl (C12-C14) dimethyl amine oxide, stearyl dimethyl amine oxide, tertiary alkyl amine oxide, alkyl dihydroxyl ethyl amine oxide, alkyl dihydroxyl ethyl lauramine oxide, alkyl dihydroxyl ethyl stearamine oxide, alkyl dihydroxyl ethyl tallowamine oxide, 2,2′-(Z)-octadec-9-en-1-ylimino) bisethanol amine oxide, cocoylamido propyldimethyl amino oxide, coconut amido alkyl amine oxide, cocamide propylamine oxide, dihydroxyethyl amine oxide, N-methylmorpholine amine oxide, pyridine amine oxide or combinations of two or more of the above amine oxides. Additional amine oxides that may be included in the composition are those such as isoalkyl dimethyl amine oxides and alkyl oxypropylamine or ether amine oxides (Tomamine AO-405, Tomamine AO-455, Tomamine AO-14-2, Tomamine AO-728 special).

Amine oxides can enhance the efficacy of some antimicrobials, including those mentioned above and can include: peroxides such as hydrogen peroxide and alpha-hydroxy acids such as lactic acid, formic acid, citric acid, mandelic acid, and glycolic acid; and quaternary ammonium compounds such as didecyl dimethyl ammonium chloride (such as Bardac® 2280) and glycol ethers such as phenoxyethanol.

Other antimicrobial components that may react with amine oxides so that they produce a synergistic or enhanced ability to kill microorganisms include straight chain alcohols such as ethanol, propanol and isopropyl alcohol. The composition may also include certain phosphate esters such as Ethoxylated Alcohols Phosphate Esters which may act synergistically with such component as amine oxides and hydrogen peroxide. Other components that may be used in the composition are certain dyes or stains such as methylene blue, which itself has antimicrobial characteristics, but can also act synergistically with amine oxides and hydrogen peroxide together.

Yet another antimicrobial chemical component that may react with amine oxides to increase antimicrobial efficacy, with or without hydrogen peroxide, are mid-chain fatty acids such as heptanoic acid, octanoic acid, nonanoic acid, and decanoic acid.

Amine oxides are not generally considered to be antimicrobials by chemists and engineers and others in the dairy industry, but the present invention demonstrates that when amine oxides are added to certain antimicrobial chemicals, such as those identified herein, there is a significant enhancement in bactericidal efficacy. The data in laboratory bactericidal efficacy tests demonstrate an increase in bactericidal efficacy when amine oxides are added to formulations containing one or more of the various above mentioned antimicrobial chemicals against such mastitis-causing pathogens as Staphylococcus aureus, Escherichia coli, Klebsiella pneumoniae, Streptococcus agalactiae, Streptococcus uberis and Pseudomonas aeruginosa. For example, one of the most resistant mastitis pathogens against oxidizing germicides, Staph aureus, was used to test the bactericidal efficacy of a hydrogen peroxide base formula with varying amounts of an amine oxide (lauryl dimethyl amine oxide or tradename Barlox® 12). (See: Table 1.) This showed an increasing kill rate as the amount of the amine oxide increased from 0% to 5% when mixed with a peroxide base, for example.

TABLE 1

| Treatment—Staph. aureus | | % | |
|---|---|---|---|
| ATCC # 6538 | CFU/ml ^{a} | Survival | % Kill |
| Negative Control | 1.73 to | — | — |
| | 6.10 × 10⁸ | | |
| Peroxide base^{b} + 0% Barlox 12^{c} | 1.40 × 10⁸ | 80.9% | 19.1% |
| Peroxide base^{b} + 0.5% Barlox 12^{c} | 1.70 × 10⁸ | 98.3% | 1.70% |
| Peroxide base^{b} + 1% Barlox 12^{c} | 1.72 × 10⁷ | 9.94% | 90.1% |
| Peroxide base^{b} + 2% Barlox 12^{c} | 1.26 × 10⁵ | 0.047% | 99.95% |
| Peroxide base^{b} + 3% Barlox 12^{c} | 2.86 × 10⁴ | 0.0047% | 99.995% |
| Peroxide base^{b} + 4% Barlox 12^{c} | 2.65 × 10³ | 0.00043% | 99.9996% |
| Peroxide base^{b} + 5% Barlox 12^{c} | 1.18 × 10³ | 0.00019% | 99.9998% |

^{b}contains 0 3% hydrogen peroxide, 1.0% Glycolic acid, 1.0% lactic acid, 5.0% n-propanol, 0.1% non-ionic surfactant (Iconol 24-9), 0.17% citric acid, 0.1% urea, 0.02% NaOH, 20.0% Glycerin,
^{c}Diluted with whole milk at a ratio of 1:1.

The present invention utilizes an amine oxide, which is non-irritating to dairy animal skin and is even commonly used in cosmetic products for humans. This component is combined with one or more known germicides that are irritating at the concentrations necessary for effective germicidal activity, and/or antimicrobials that have little or no teat irritation at higher concentrations, but have not been accepted for teat antisepsis due to insufficient efficacy for a teat dip. Those types of antimicrobials include: weak acids such as alpha-hydroxy acids, lactic acid, citric acid; or glycol ethers such as phenoxyethanol or other antimicrobials that have a limited spectrum of efficacy, such as quaternary ammonium compounds or low molecular weight alcohols. Germicides that are popular for pre-milking teat antisepsis, such as hydrogen peroxide, but are irritating when used at effective concentrations on teat skin in a post milking application would benefit when combined at a low concentration with a synergist, such as an amine oxide, in accordance with the present invention. Therefore, the result of this combination is an effective teat antiseptic that is also non-irritating and non-toxic.

A preferred formulation for the present invention is as follows:

| Ingredient | Percentage |
|---|---|
| Soft Water | 74.01 |
| Caustic Soda 40% | 0.02 |
| Emollients | 20.00 |
| Citric Acid | 0.170 |
| Glycolic (hydroxyacetic) Acid (70%) | 1.4300 |
| Lactic Acid (80%) | 1.1400 |
| Iconol 24-9 | 0.10 |
| Urea Prilled Uncoated | 0.10 |
| Hydrogen Peroxide 34% | 0.40 |
| Barlox 12 | 4.00 |
| N-Propanol | 5.00 |
| Yellow #5 Dye | 0.2000 |

Other advantages of the present invention are that none of the ingredients, neither the amine oxide synergist nor the germicides that are synergistic with the amine oxides, are themselves based on materials of which the global supply might be finite and eventually scarce, as is the case with iodine. Amine oxides and the majority of the synergistic germicides are plentiful, readily obtainable, not dependent on any finite raw material that is extracted from the ground, are utilized in many other industrial and consumer applications and products, and are relatively inexpensive. These ingredients are also not harmful to the environment and are readily degraded and, therefore, will not accumulate in or pollute soil or waterways into which they may be expelled after use. A further advantage to the present invention is that the antimicrobials that would be used in combination with the amine oxides are recognized in many countries where the use of teat antiseptics are regulated by governmental authorities for veterinary uses such as the European Union, South America, and Canada, as is the case for peroxides and for some alpha hydroxy acids.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be appreciated that the construction and arrangement of the method, as shown in the various exemplary embodiments, is illustrative only. While the method, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the method, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

1. A method for reducing the incidence of mastitis in dairy animals, the method comprising the step of:
topically applying an antimicrobial composition onto the teats or udder of the animal, the composition comprising:
a first component comprising from about 2.0% to about 20.0% by weight of the composition of an amine oxide surfactants; and
a second component comprising from about 0.01% to about 0.5% by weight of the composition of an oxidizing agent.

2. The method of claim 1, wherein the amine oxide includes N-Alkyl (C10-18) dimethylamine oxides selected from the group comprising:
decyl dimethylamine oxide, lauryl (dodecyl) dimethylamine oxide or myristyl dimethyl amine oxide, or combinations thereof.

3. The method of claim 1 wherein the second component is selected from the group comprising:
hydrogen peroxide, peroxyacetic acid, lactic acid, glycolic acid, tartaric acid, citric acid, mandelic acid, malic acid, or a halogen selected from the group comprising iodine derivatives, chlorine derivatives, bromine derivatives, or combinations thereof.

4. A method for reducing the incidence of mastitis in dairy animals, the method comprising the steps of:
topically applying an antimicrobial composition to the teat or udder of the animal, wherein the antimicrobial composition comprises:
a first component comprising from about 2.0% to about 20.0% by weight of the composition of an amine oxide surfactant; and
a second component comprising from about 0.5% to about 20% by weight of the composition of a germicide comprising a cationic agent, a glycol ether, an alcohol, an antimicrobial dye, or combinations thereof.

5. The method of claim 4, wherein the cationic agent in second component comprises:
a quaternary ammonium compound.

6. The method of claim 4, wherein the second component further comprises:
a didecyl dimethyl ammonium salt.

7. The method of claim 6, wherein the didecyl dimethyl ammonium salt includes:
chloride or monoalkyl dimethyl benzyl ammonium salts or monoalkyl dimethyl ammonium salts or heteroaromatic ammonium salts, or bis-quaternary ammonium salts.

8. The method of claim 4, wherein the second component comprises phenoxyethanol.

9. The method of claim 4, wherein the second component comprises n-propanol, iso-propanol, ethanol, benzyl alcohol, or combinations thereof.

10. The method of claim 4 wherein the second component comprises methylene blue.

11. A method for reducing the incidence of mastitis in dairy animals, the method comprising the steps of:
topically applying an antimicrobial composition to the teat or udder of the animal wherein the antimicrobial composition comprises:
a first component comprising from about 2.0% to about 20.0% by weight of the composition of an amine oxide surfactant; and
a second component comprising from about 0.5% to about 20% by weight of the composition of a germicide comprising a mid-chain carboxylic acid.

12. The method of claim 11, wherein the second component comprises:
a mid-chain carboxylic acid includes:
hexanoic acid, heptanoic acid, octanoic acid, nonanoic acid, decanoic acid, undecanoic acid, dodecanoic acid, tridecanoic acid, tetradecanoic acid, and combinations thereof.

13. A method for reducing the incidence of mastitis in dairy animals, the method comprising the steps of:
topically applying an antimicrobial composition to the teat or udder of the animal, wherein the antimicrobial composition comprises:
a first component comprising from about 2.0% to about 20.0% by weight of the composition of one or more amine oxide surfactants; and
a second component comprising from about 0.5% to about 20% by weight the composition of a germicide comprising:
a peracid and an alpha hydroxyl acid;
an alpha hydroxyl acid;
a cationic agent;
a glycol ether; or
combinations thereof.

14. The method of claim 13, wherein the cationic agent comprises: a quaternary ammonium compound.
